(19) United States
(12) Patent Application Publication
(10) Pub. No.: US 2021/0096699 A1
(43) Pub. Date: Apr. 1, 2021

(54) SYSTEM AND METHOD FOR CONTROLLING APPLICATION AND USER INTERFACE SETTINGS ON A MOBILE DEVICE

(71) Applicant: Toshiba TEC Kabushiki Kaisha, Shinagawa-ku (JP)

(72) Inventors: Louis ORMOND, Irvine, CA (US); Silvy WILSON, Rancho Santa Margarita, CA (US)

(21) Appl. No.: 16/585,813

(22) Filed: Sep. 27, 2019

(51) Int. Cl. G06F 3/0482; G06F 3/0484; G06F 3/0488; G06F 11/34; H04W 4/029

(52) U.S. Cl. CPC G06F 3/0482; G06F 3/04845; H04W 4/029; G06F 11/3438; G06F 3/04883

(57) ABSTRACT

A system and method for controlling applications and user interface settings on portable digital devices such as smartphones or tablets monitors a device location and applications or images that are used in such locations. A usage frequency is also monitored and updated as applications are launched by a user. Automated or assisted ordering of application icons is made based on frequency of use. Most frequently used applications have icons displayed on a home screen, in order of use frequency for a given location. Icons or device wallpaper are automatically altered in accordance with popularity of use at a different location when the device is relocated there. Suggestions for applications are made based on use frequency and locations of other users.

### TECHNICAL FIELD

This application relates generally to user interfaces on portable data devices. The application relates more particularly to generating a touchscreen display on a portable data device, such as a smartphone or tablet wherein application launch icons are displayed and ordered in accordance with a use frequency at a particular device location.

### BACKGROUND

Portable data devices, such as tablets or smartphones, are ubiquitous. Devices function for many different aspects of life, including telecommunications, digital messaging, social media, gaming, document processing and picture taking. Various functions are accomplished by launching an associated application (“app”), typically by tapping on its associated icon on a touchscreen display. Displays, particularly smaller displays on a smartphone, can only display a limited number of icons concurrently. User's typically set up their displays such that icons to launch applications that are most frequently used appear on a startup or home screen. Other application icons will be ordered on subsequent screen pages, typically selected by swiping over the touchscreen. Users may have many pages of application icons, and find themselves swiping to more and more levels to get to the icons they need to launch a desired application.

### BRIEF DESCRIPTION OF THE DRAWINGS

Various embodiments will become better understood with regard to the following description, appended claims and accompanying drawings wherein:

FIG. 1 is an example embodiment of a system for controlling application and user interface settings on a mobile device;

FIG. 2 is another example embodiment of a system for controlling application and user interface settings on a mobile device;

FIG. 3 is an example embodiment of a portable digital device such as a smartphone; and

FIG. 4 is an example embodiment of a flow diagram for smartphone attribute based user interface customization.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

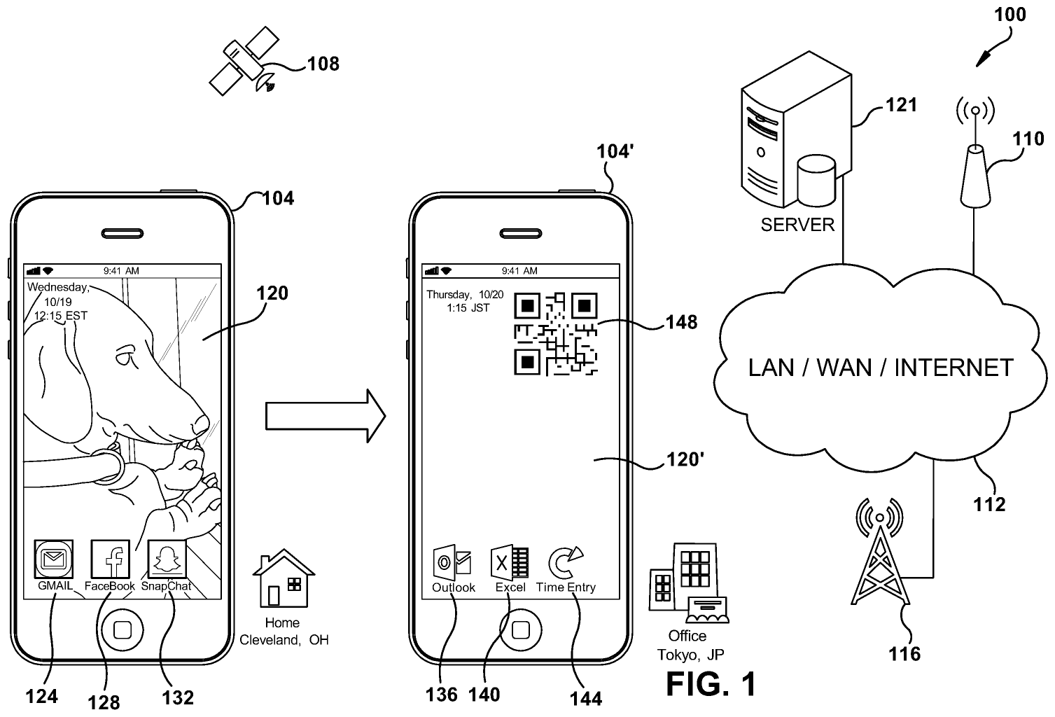

In accordance with the subject application, FIG. 1 illustrates an example embodiment of a system 100 for controlling application and user interface settings on a mobile device. Included is a portable data device, such as a tablet, notebook computer or smartphone. While any portable data device is suitable, the example embodiment of FIG. 1 is illustrated in accordance with smartphone 104. A location of smartphone 104 is determined, such as via GPS satellites, illustrated by satellite 108. Location is done by any suitable means or combination of means, including Wi-Fi, such as via hotspot 110, Bluetooth, cell tower, near field communication (NFC), or the like. Network cloud 112 is comprised of any suitable local area network (LAN), wide area network (WAN), which may comprise the Internet, or cellular network, such as with cell tower 116, or any suitable combination thereof. Location, actual or prospective, may also be supplied by a user. Smartphone 104 includes a display, comprised of touchscreen display 120. Applications and associated icons for smartphone 104 are suitably downloaded from a network source, such as server 121. A server, such as server 121, suitably provides for monitoring of data from other application users on the same or different portable data devices. Aggregation of such data can also be used for selection and ordering of applications, as well as form a basis for application suggestions. For example, if it is determined that users at the office frequently use a particular application, which application does not appear on another employee's smartphone, a suggestion can be supplied to that employee that they may wish to consider adding or using this application.

A memory of smartphone 104 stores applications and associated icons, as well as one or more images. For example, images may include digital photos supplied by a user or a device camera, or any other suitable digital image. Smartphone 104 may display any image, static or changing, which display may be a background image, such as display wallpaper.

In the illustrated example embodiment of FIG. 1, smartphone 104 is located at a user's home and moved to the user's office as illustrated by 104′ and touchscreen display 120′. Home and office location is for example only. It is understood that any display modifications as described herein may be associated with any location, such as while in motion, at school, at church, at a store, at a restaurant, or the like. Icons associated with applications used at home, for example, are determined and displayed based on frequency of application launches at an associated location as will be described in further detail below. In the example, home interface 120 displays a user's personal email 124 and social media applications 128 and 132. Home interface 120 also displays a wallpaper of the user's dog, selected for display while at home. Any or no image or scheme may be associated with a location.

When located at the user's office, smartphone 104′ displays no wallpaper on display 120′. Icons for frequently used applications at the office include office e-mail application 136, a document processing application 140 and a time entry application 144. Display 120′ can also display other indicial, such as QR code 148 which may serve office functions such as device logins, unlocking doors or employee identification.

In a particular example of FIG. 1, certain icons may be selected for display at a selected location by a user. In another example, application launches are counted for each application. Counts may be a total number of application launches, or a count for a number or frequency of application launches tied to a particular location. Icons can be displayed in accordance with a frequency of launches at a location. When a number of concurrently displayable icons is fixed or limited, as to any integer N, then only the N most launched applications will have their icons displayed. Icons which are displayed concurrently are suitably ordered on the display in accordance with relative frequency of use among them. For example, in western cultures, reading is typically done left-to-right and top-to-bottom. In such situations, a most frequently called icon is positioned at the top left of the display, and the Nth most frequently called icon is displayed at the bottom right of the display. Any suitable ordering may be specified. When a count is updated, a reordering can determine which icons will now be displayed and in which order. Thus, when an icon becomes less and less frequently used, it is moved down and right, until it reaches N+1 when it becomes hidden, or moved to a second screen or beyond. It is to be appreciated that such listings can extend to multiple screens, wherein, for example, screen two displays icons N+1 to 2N, ordered left-to-right, top-to-bottom.

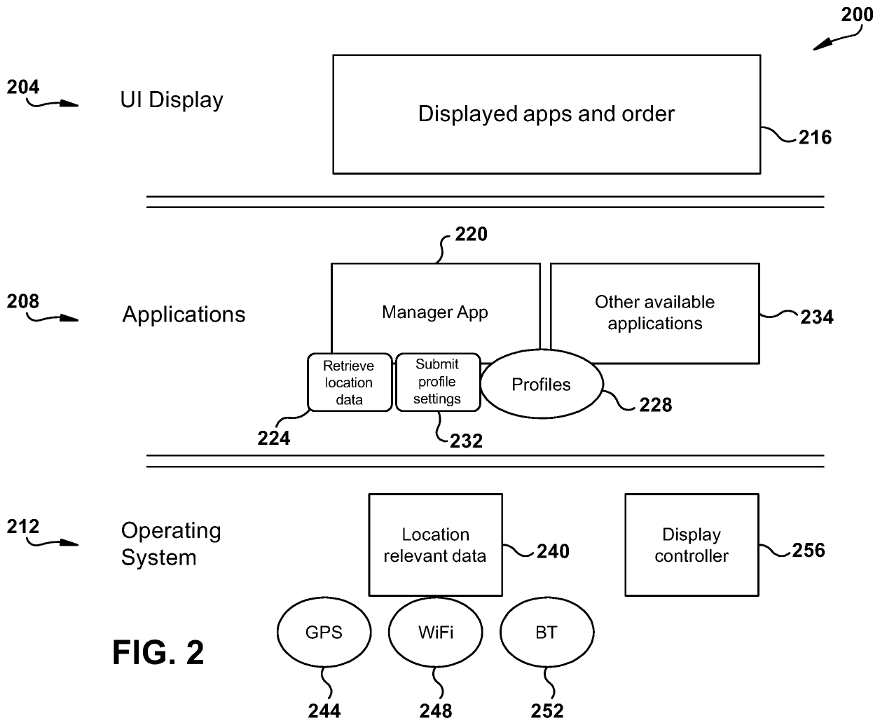

FIG. 2 illustrates an example embodiment of a system 200 for controlling application and user interface settings on a mobile device. The system includes a user interface display 204, applications 208 and an operating system 212. User interface display 204 provides a display 216 of ordered applications. Applications 208 include an application manager 220 and location data 224, as well as user profile information 228 and user profile settings 232. One or more additional applications is illustrated by block 234. Hardware/software operating system 212 includes a location system or means 240, suitably comprising one or more or GPS 244, Wi-Fi 248 or Bluetooth 252. Operating system 212 also includes display controller 256.

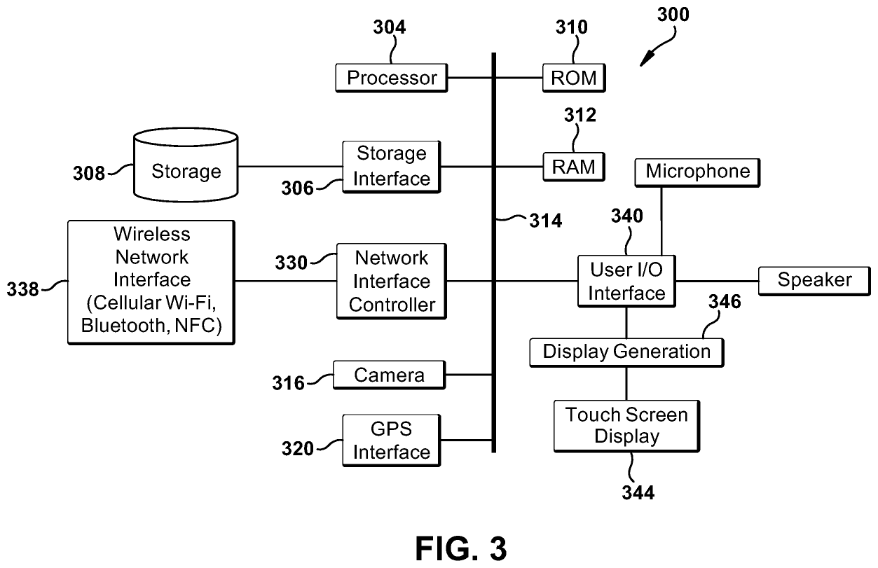

Turning now to FIG. 3, illustrated is an example of a portable digital device 300 suitably comprising smartphone 104 of FIG. 1. Included are one or more processors, such as that illustrated by processor 304. Each processor is suitably associated with non-volatile memory, such as read only memory (ROM) 310 and random access memory (RAM) 312, via a data bus 314. Also in data communication with data bus 314 is digital camera 316 and GPS interface 320.

Processor 304 is also in data communication with a storage interface 306 for reading or writing to a data storage system 308, suitably comprised of a hard disk, optical disk, solid-state disk, or any other suitable data storage as will be appreciated by one of ordinary skill in the art.

Processor 304 is also in data communication with a network interface controller (NIC) 330, which provides a data path to any suitable network or device connection, such as a suitable wireless data connection via wireless network interface 338. A suitable data connection to an MFP or server is via a data network, such as a local area network (LAN), a wide area network (WAN), which may comprise the Internet, or any suitable combination thereof. A digital data connection is also suitably directly with an MFP or server, such as via BLUETOOTH, optical data transfer, Wi-Fi direct, NFC or the like.

Processor 304 is also in data communication with a user input/output (I/O) interface 340 which provides data communication with user peripherals, such as touch screen display 344 via display generator 346, as well as keyboards, mice, track balls, touch screens, or the like. It will be understood that functional units are suitably comprised of intelligent units, including any suitable hardware or software platform.

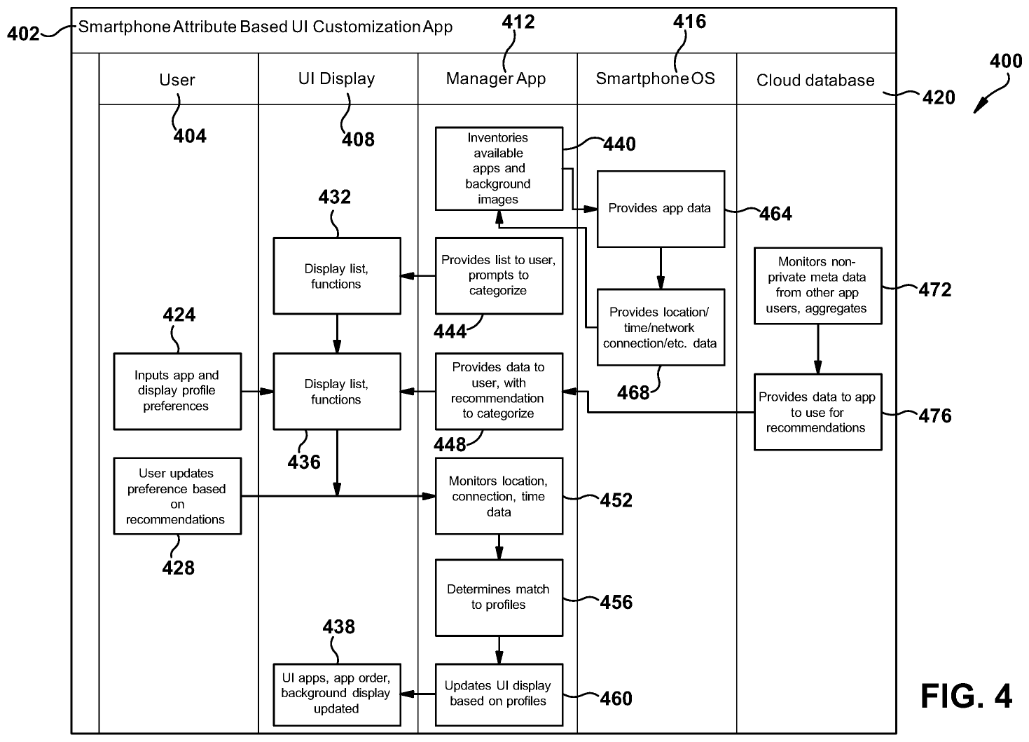

FIG. 4 illustrates an example embodiment of a flow diagram 400 for smartphone attribute based user interface customization. This is suitably accomplished in conjunction with a smartphone attribute based user interface customization application 402 working in tandem with user 404, user interface display 408, manager application 412, smartphone operating system 416 and cloud database 420.

In FIG. 4, user 404 interactions include inputting applications or display profile preferences at block 424, as well as adjusting preferences based on received recommendations at block 428. User interface display 408 displays a first list of functions at block 432 and a second list of functions at block 436. User interface applications, background, and display order is updated at block 438.

Manager application 412 provides inventories of available applications and images, such as background images, at block 440. A list can be provided at block 444 with a corresponding prompt for user categorization, which output provides input to block 432, noted above. Data is provided to user 404, along with recommendations for categorization, at block 448 and which provides input to block 436, noted above. Manager application 412 also monitors connections, date and time at block 452, and determines profile matches at block 456. Updates to user interface profiles are completed at block 460, which results form an input to block 438, noted above.

Smartphone operating system 416 functions to provide application data at block 464, and location, time, date, network connection information, and the like at block 468. This forms an input to block 440, as noted above.

Cloud database 420 functions to monitor private metadata from other applications, users, locations, times, and the like at block 472, and provides user recommendations at block 476. This output forms an input to block 448, as noted above.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A portable data device comprising:
a memory configured to store a plurality of images,
the memory further configured to store a plurality of applications, each application including associated icon data and an associated history value corresponding to a frequency and location of launches thereof;
a touchscreen display;
a location means for determining a location of the portable data device; and
a processor configured to order the applications in accordance with their associated launch frequency at a determined location,
the processor further configured to display icons on the touchscreen associated with most frequently launched applications at the determined location.

2. The portable data device of claim 1 wherein the processor is configured to generate a display on the touchscreen showing a specified number of N icons concurrently, wherein N is any positive integer, such that the N icons correspond to the N most frequently launched applications at the determined location.

3. The portable data device of claim 2 wherein the N icons are ordered on the display in accordance with relative frequency of launches of their associated applications.

4. The portable data device of claim 1 wherein the location means is comprised of a location supplied by user input.

5. The portable data device of claim 1 wherein the location means is comprised of one or more of GPS location, Wi-Fi location, Bluetooth location, NFC location or location based on a set location for a time, date or day of week.

6. The portable data device of claim 1 wherein the touchscreen is configured to receive a user application launch instruction, and wherein a count value is incremented for a launch frequency of an application corresponding to a received user application launch instruction.

7. The portable data device of claim 6 wherein the applications have a plurality of count values, each count value corresponding to application launches at a different location.

8. The portable data device of claim 1 wherein the processor is further configured to display a background image on the touchscreen display in accordance with a determined location.

9. A method comprising:
storing, in a memory, a plurality of applications, each application including associated icon data and an associated history value corresponding to a frequency and location of launches thereof;
determining a location of the portable data device;
ordering, via a processor, the applications in accordance with their associated launch frequency at a determined location; and
displaying icons on a touchscreen, which icons are associated with most frequently launched applications at the determined location.

10. The method of claim 9 further comprising generating a display on the touchscreen showing a specified number of N icons concurrently, wherein N is any positive integer, such that the N icons correspond to the N most frequently launched applications at the determined location.

11. The method of claim 10 ordering the N icons on the display in accordance with relative frequency of launches of their associated applications.

12. The method of claim 9 further comprising determining the location of the portable data device in accordance with user input.

13. The method of claim 9 further comprising determining the location of the portable data device by of one or more of GPS location, Wi-Fi location, Bluetooth location, NFC location or location based on a set location for a time, date or day of week.

14. The method of claim 9 further comprising receiving a user application launch instruction and incrementing a count value for a launch frequency of an application corresponding to a received user application launch instruction.

15. The method of claim 14 further comprising storing a plurality of count values for each application wherein each count value is associated with a different location.

16. The method of claim 9 further comprising displaying a background image on the touchscreen display in accordance with a determined location.

17. A portable data device comprising:
a memory configured to store a plurality of images,
the memory further configured to store a plurality of applications, each application including associated icon data and an associated history value corresponding to a frequency and location of launches thereof;
a touchscreen display;
a location means for determining a location of the portable data device; and
a processor configured to order the applications in accordance with their associated launch frequency at a determined location,
the processor further configured to display icons on the touchscreen associated with most frequently launched applications at the determined location, wherein displayed icons are displayed in an order corresponding to relative frequency of associated launch frequencies.

18. The portable data device of claim 17 wherein the processor is further configured to increment a launch frequency associated with each application as it is launched corresponding to a determined location at which it is launched.

19. The portable data device of claim 18 wherein the processor is further configured to reorder the applications in accordance with frequency of launches at the determined location after each application is launched.

20. The portable data device of claim 19 wherein the processor is further configured to display an image on the touchscreen in accordance with a determined location.
